(19) United States
(12) Patent Application Publication
(10) Pub. No.: US 2026/0095818 A1
(43) Pub. Date: Apr. 2, 2026

(54) RESOURCE ALLOCATION METHOD, BASE STATION, AND READABLE STORAGE MEDIUM

(71) Applicant: REALME MOBILE TELECOMMUNICATIONS (SHENZHEN) CO., LTD., Shenzhen (CN)

(72) Inventor: Yuchun LUO, Shenzhen (CN)

(21) Appl. No.: 19/411,301

(22) Filed: Dec. 7, 2025

Related U.S. Application Data
(63) Continuation of application No. PCT/CN2024/102373, filed on Jun. 28, 2024.

(30) Foreign Application Priority Data
Jul. 20, 2023 (CN) 202310897201.5

(51) Int. Cl. H04W 28/26; H04B 17/318; H04W 72/0453; H04W 72/51; H04W 72/566

(52) U.S. Cl. CPC H04W 28/26; H04B 17/318; H04W 72/0453; H04W 72/51; H04W 72/566

(57) ABSTRACT

Provided are a resource allocation method, a base station, and a non-transitory readable storage medium. The method includes operations as follows. In response to a first service preempting resources of a second service, reserved resources for the second service are allocated to the first service, where a priority of the first service is higher than a priority of the second service. The second service is switched to target resources, where the target resources are resources different from the reserved resources.

### CROSS-REFERENCE OF RELATED APPLICATIONS

This application is a continuation of International Application No. PCT/CN2024/102373, field Jun. 28, 2024, which claims priority to Chinese Patent Application No. 2023108972015, filed Jul. 20, 2023, the entire disclosures of which are incorporated herein by reference.

### TECHNICAL FIELD

The disclosure relates to the field of communication technologies, and particularly to a resource allocation method, a base station, and a non-transitory readable storage medium.

### BACKGROUND

With the development of communication technologies, different types of services have different requirements for latency and rate. Multiple services may be scheduled concurrently in one network.

In the related art, when a high-priority service requires to be allocated with resources but there is no idle resource at this time, the base station would preempt resources of a low-priority service and allocate the preempted resources to the high-priority service for use. However, in the related art, the service whose resources are preempted would be interrupted for a long time.

### SUMMARY

Embodiments of the disclosure provide a resource allocation method, a base station, and a non-transitory readable storage medium.

In a first aspect, the embodiments of the disclosure provide a resource allocation method. The method is implemented by a base station, and includes:
in response to a first service preempting resources of a second service, allocating reserved resources for the second service to the first service, where a priority of the first service is higher than a priority of the second service; and
switching the second service to target resources, where the target resources are resources different from the reserved resources.

In a second aspect, the embodiments of the disclosure provide a base station. The base station includes a transceiver, a memory and a processor, where the memory stores a computer program which, when being executed by the processor, causes the processor to execute operations of the resource allocation method according to the first aspect.

In a third aspect, the embodiments of the disclosure provide a non-transitory computer-readable storage medium. The computer-readable storage medium stores thereon a computer program which, when being executed by a processor, causes operations of the resource allocation method according to the first aspect to be implemented.

### BRIEF DESCRIPTION OF THE DRAWINGS

In order to more clearly illustrate technical solutions in the embodiments of the disclosure or in the related art, drawings to be used in the embodiments or in the related art are briefly described below. Apparently, the following drawings are merely some embodiments of the disclosure, and a person skilled in the art can obtain other drawings according to the given drawings without paying any creative effort.

FIG. 1 is a diagram illustrating an application environment to which a resource allocation method according to the embodiments of the disclosure is applicable.

FIG. 2 is a flowchart of a resource allocation method according to an embodiment.

FIG. 3 is a flowchart of a resource allocation method according to another embodiment.

FIG. 4 is a flowchart of a resource allocation method according to yet another embodiment.

FIG. 5 is a flowchart of a resource allocation method according to still another embodiment.

FIG. 6 is a flowchart of a resource allocation method according to still yet another embodiment.

FIG. 7 is a structural diagram of a resource allocation apparatus according to an embodiment.

FIG. 8 is a structural diagram of a resource allocation apparatus according to another embodiment.

FIG. 9 is a structural diagram of a resource allocation apparatus according to yet another embodiment.

FIG. 10 is a structural diagram of a resource allocation apparatus according to still another embodiment.

FIG. 11 is a structural diagram of a resource allocation apparatus according to still yet another embodiment.

FIG. 12 is a structural diagram of a resource allocation apparatus according to still yet another embodiment.

FIG. 13 is a structural diagram of a resource allocation apparatus according to still yet another embodiment.

FIG. 14 is a structural diagram of a resource allocation apparatus according to still yet another embodiment.

FIG. 15 is a structural diagram of a resource allocation apparatus according to still yet another embodiment.

FIG. 16 is a structural diagram of a resource allocation apparatus according to still yet another embodiment.

FIG. 17 is a structural diagram of a resource allocation apparatus according to still yet another embodiment.

FIG. 18 is a structural diagram of a base station according to an embodiment.

### DETAILED DESCRIPTION OF PREFERRED EMBODIMENTS

The technical solutions in the embodiments of the disclosure will be clearly and comprehensively described below in conjunction with the drawings in the embodiments of the disclosure. Apparently, the described embodiments are only a part of the embodiments of the disclosure, not all of the embodiments. All other embodiments obtained by a person skilled in the art based on the embodiments of the present disclosure without creative efforts shall fall within the protection scope of the present disclosure.

In order to make the purposes, technical solutions and advantages of the disclosure more comprehensible, the disclosure is further described in detail below in conjunction with the drawings and embodiments. It should be understood that the specific embodiments described herein are only used to explain the disclosure and are not intend to limit the disclosure.

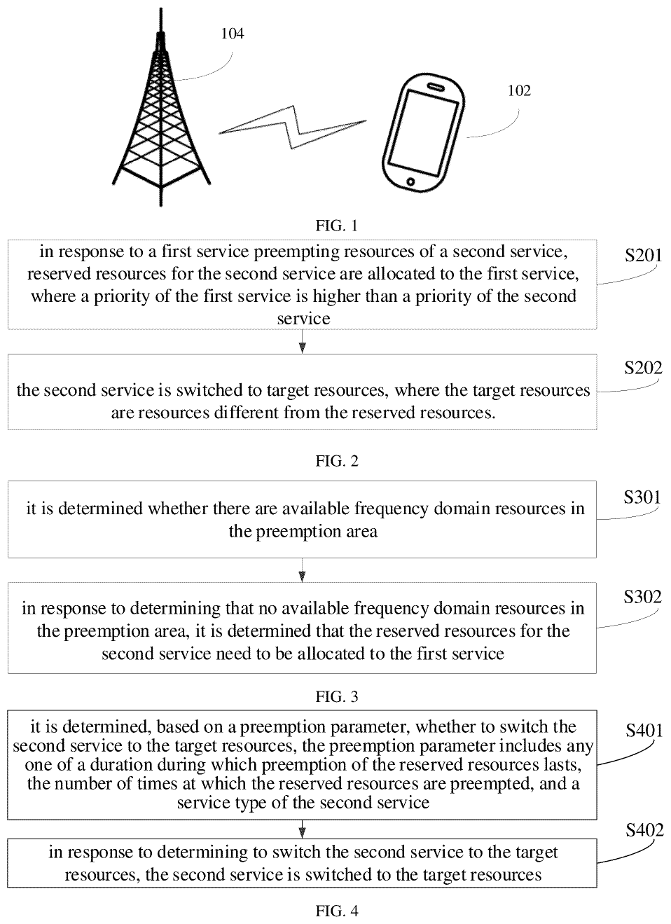

The resource allocation method provided in the embodiments of the disclosure may be applied to the application environment illustrated in FIG. 1. Specifically, a base station 104 is a device deployed in an access network to provide wireless communication functions for a terminal 102. In systems adopting different wireless access technologies, the names of devices with base station functions may be different. For example, in a Long Term Evolution (LTE) system, it is named evolved Node B (eNodeB or eNB); and in a 5th Generation Mobile Communication Technology (5G) New Radio (NR) system, it is named next Generation NodeB (gNodeB or gNB). Wireless communication may be carried out between the terminal 102 and the base station 104. The terminal 102 may be a smart phone, a tablet computer, a personal computer, a laptop, a wearable device, a vehicle-mounted device, etc., and the base station 104 may be any type of base station device, such as a macro base station, a micro base station, or a pico base station.

Currently, 5G network defines three service types, including Ultra-Reliable and Low Latency Communications (URLLC) service, Enhanced Mobile Broadband (eMBB) service, and Massive Machine-Type Communications (mMTC) service. Different services have different latency and rate requirements, and multiple services may be scheduled concurrently in one network. The communication protocol does not specify the resource allocation for these three services, so that various manufacturers have choices to implement different resource allocations. When a high-priority service (for example, a URLLC service with strict latency requirements) needs to be allocated with resources but there is no idle resource at this time, the network would preempt the resources allocated to a low-priority service (for example, an eMBB service with relatively loose latency requirements) for the high-priority service. This may cause service interruption for the preempted low-priority service. Furthermore, the low-priority service would suffer from long-term service interruption, if the resources allocated to the low-priority service are concentrated in a preemption area. In view of this, a resource allocation method and apparatus, a base station, a readable storage medium, and a program product are provided in the disclosure, in order to avoid the problem of long-term service interruption for a service whose resources are preempted.

In some embodiments, a resource allocation method as illustrated in FIG. 2 is provided. Taking a case where the method is applied to the base station shown in FIG. 1 as an example, the method includes operations as follows.

At S201, in response to a first service preempting resources of a second service, reserved resources for the second service are allocated to the first service, where a priority of the first service is higher than a priority of the second service.

The first service is a high-priority service, and the second service is a low-priority service. The high-priority service has strict latency requirements, such as a URLLC service. The low-priority service has relatively loose latency requirements, such as an eMBB service.

It is notable that a service carries a Quality of Service (QoS) parameter when the service is initiated by a terminal, and the base station may determine, based on the QoS parameter, whether the service is a high-priority service. For example, the base station may determine, based on the QoS parameter, whether there is a terminal accesses the network for a URLLC service or an automatic driving Vehicle-to-Everything (V2X) service; and if there is a terminal accessing the network for these services or a terminal initiating these services, the base station determines that there is a high-priority service in progress.

In addition, in a case where the base station determines that the first service with high priority accesses the network, when no resources in the network may be allocated to the first service, the base station may determine that the reserved resources for the second service with low-priority are required to be allocated to the first service with high priority. In this case, the base station may allocate the reserved resources for the second service to the first service.

At S202, the second service is switched to target resources, where the target resources are resources different from the reserved resources.

In the embodiments, after the base station allocates the reserved resources for the second service to the first service, the first service is enabled to operate using the allocated reserved resources. In addition, the base station may switch (hand over) the second service to the target resources different from the reserved resources. This allows the second service to continue operating with the target resources switched to, thus avoiding the service interruption of the second service that would otherwise be caused by a fact that the resources for the second service are allocated to the first service.

In the embodiments, as an alternative implementation, the base station may switch the second service to the target resources different from the reserved resources, through a Radio Resource Control (RRC) connection reconfiguration message or Downlink Control Information (DCI).

In the embodiments, as an alternative implementation, the base station may allocate all or a part of the reserved resources for the second service to the first service with high priority, and the reserved resources allocated to the first service are not limited herein.

In the resource allocation method, when the first service with high priority needs to preempt resources of the second service with low priority, the reserved resources for the second service are allocated to the first service, and the second service is switched to target resources different from the reserved resources. This enables the first service to continue operating with the allocated reserved resources, and the second service can continue operating with the target resources switched to. On the premise of ensuring the operation of the first service, it avoids the problem of long-term service interruption of the second service after the resources of the second service are allocated to the first service, and it enables the second service to operate continuously using other resources.

In the above scenario where the reserved resources for the second service are allocated to the first service and the second service is switched to the target resources, it needs to pre-allocate the reserved resources and the target resources to the second service. In some embodiments, the method further includes: operation A, the reserved resources from a preemption area are allocated to a target terminal corresponding to the second service, and the target resources outside the preemption area are allocated to the target terminal, where the preemption area includes reserved frequency domain resources.

In the embodiments, the preemption area includes reserved frequency domain resources that are pre-determined from total frequency domain resources of the network, that is, the base station may determine a portion of the total frequency domain resources of the network as the preemption area. Furthermore, it is understood that the base station allocates the reserved resources from the preemption area to the target terminal corresponding to the second service, that is, the reserved resources allocated by the base station to the target terminal corresponding to the second service are frequency domain resources determined from the reserved frequency domain resources included in the preemption area.

The specific implementations for determining the preemption area are described below.

In a first implementation, the base station may determine the preemption area, based on the total frequency domain resources of the network and a preset preemption resource proportion. For example, the preset preemption resource proportion may be 5%, that is, the base station may determine 5% of the total frequency domain resources of the network as the preemption area.

In a second implementation, the base station may determine the preemption area from the total frequency domain resources of the network, based on the quantity of resources of the first service during a historical time period. For example, the base station may determine the preemption area based on a peak quantity of the frequency domain resources used by the first service with high priority per unit time in the past week. Exemplarily, the base station may determine, from the total frequency domain resources of the network, frequency domain resources whose quantity is equal to the peak quantity of the frequency domain resources used by the first service per unit time in the past week, as the preemption area. Alternatively, the base station may determine the preemption area from the total frequency domain resources of the network, based on a proportion of the peak quantity of the frequency domain resources used by the first service per unit time in the past week to the total frequency domain resources of the network.

It is notable that Bandwidth Part (BWP) is a technology introduced in 5G networks, which enables a terminal to operate at a specific frequency band (i.e., BWP) of the entire 5G band. The bandwidth of 5G is relatively large, and if each terminal monitors channels and transmits data across the entire bandwidth, high power consumption of the terminals would be caused. In addition, different carrier intervals may be set for each BWP to accommodate diverse service requirements. The BWP for each terminal is allocated by the base station, in which multiple BWPs may be allocated, but only one BWP is activated. The reserved resources and the target resources in the embodiments refer to the multiple BWPs allocated to the target terminal. In the embodiments, as an alternative implementation, the base station may allocate the reserved resources from the preemption area to the target terminal and allocate the target resources outside the preemption area to the target terminal, based on an allocation strategy that the frequency bands of the reserved resources do not overlap with the frequency bands of the target resources.

In the embodiments, the base station allocates, from the preemption area including reserved frequency domain resources, the reserved resources to the target terminal corresponding to the second service, and allocates the target resources outside the preemption area to the target terminal. In this way, when the reserved resources for the second service need to be allocated to the first service with high priority in the network, the second service is enabled to be switched to the target resources outside the preemption area. As such, the continuous operating of the second service is ensured, thereby avoiding service interruption or even long-term service interruption of the second service.

The process of determining the target terminal corresponding to the second service will be described in detail in the embodiments. In some embodiments, the method further includes: operation B, the target terminal is determined from multiple terminals in the network based on capability report information of each of the multiple terminals.

First, it is notable that the protocol specification of the 3rd Generation Partnership Project (3GPP) stipulates that, when a terminal supports its resources to be preempted, the terminal reports pre-EmptIndication-DL in the New Radio (NR) physical layer capability Phy-Parameter, so as to inform the network that the terminal's resources may be preempted. In the embodiments, as an alternative implementation, the base station may determine, based on the capability report information (i.e., reported capability information) of each terminal in the network, a terminal that reports the pre-EmptIndication-DL in the capability information as the target terminal.

In some alternative implementations, before determining the target terminal from the multiple terminals in the network based on the capability report information of each of the multiple terminals, the base station may first determine, based on the number of terminals in the network or the range of the frequency domain resources of the network, whether it needs to allocate the frequency domain resources in the preemption area. In a case where the base station determines that it needs to allocate the frequency domain resources in the preemption area, the base station then determines, based on the capability report information of each of the multiple terminals, the target terminal from the multiple terminals. For example, the base station may determine whether it needs to allocate the frequency domain resources in the preemption area, based on whether the number of terminals in the network exceeds a network capacity. That is, when the number of terminals in the network exceeds the network capacity, the base station may determine that it needs to allocate the frequency domain resources in the preemption area. As another example, the base station may determine whether it needs to allocate the frequency domain resources in the preemption area, based on whether a range of frequency domain resources currently required by all terminals in the network exceeds a range of the total frequency domain resources of the network. That is, when the range of frequency domain resources currently required by all terminals in the network exceeds the range of the total frequency domain resources of the network, the base station may determine that it needs to allocate the frequency domain resources in the preemption area. Furthermore, in a case where the base station determines that it needs to allocate the frequency domain resources in the preemption area, the base station may determine the target terminal from the multiple terminals based on the capability report information of each of the multiple terminals. It can be understood that the base station determines the target terminal from multiple terminals based on the capability report information of each of the multiple terminals, only when the base station determines that it needs to allocate the frequency domain resources in the reserved preemption area. As such, the waste of resources can be avoided.

In the embodiments, the process in which the base station determines the target terminal from the multiple terminals in the network based on the capability report information of each of the terminals is relatively simple, and it does not require excessive computational complexity. This enables the base station to quickly determine the target terminal from the multiple terminals in the network, thereby improving the efficiency of determining the target terminal.

In some scenarios, the base station may first determine, based on whether there are available frequency domain resources in the preemption area, whether it needs to allocate the reserved resources for the second service with low priority to the first service. In some embodiments, as illustrated in FIG. 3, the method further includes operations as follows.

At S301, it is determined whether there are available frequency domain resources in the preemption area.

Specifically, the available frequency domain resources may include idle frequency domain resources and remaining frequency domain resources in the preemption area.

In the embodiments, as an alternative implementation, the base station may determine, based on a current network resource load of the network, whether there are available frequency domain resources in the preemption area. For example, when the current network resource load is not heavy, the base station may determine that the frequency domain resources in the preemption area are not fully occupied, and there are available frequency domain resources in the preemption area. When the current network resource load is heavy, the base station may determine that the frequency domain resources in the preemption area have already been fully occupied, and there are no available frequency domain resources in the preemption area.

At S302, in response to there being no available frequency domain resources in the preemption area, it is determined that the reserved resources for the second service need to be allocated to the first service.

In the embodiments, when the base station determines that there are no available frequency domain resources in the preemption area, it shows that none of the reserved frequency domain resources is available. To ensure the operation of the first service with high priority, the base station needs to allocate the reserved resources for the second service with low priority to the first service.

In some alternative implementations, as another possible situation, the base station may determine that there are available frequency domain resources in the preemption area. In this case, the base station may allocate the available frequency domain resources in the preemption area to the first service with high priority, to enable the operation of the first service with high priority. It can be understood that, when there are available frequency domain resources in the preemption area, the base station allocates the available frequency domain resources in the preemption area to the first service with high priority, which can reduce unnecessary resource preemption while ensuring the operation of the second service with low priority, thereby preventing service interruption of the second service.

In the embodiments, the base station determines whether there are available frequency domain resources in the preemption area. In a case where the base station determines that no frequency domain resources are available in the preemption area, the base station determines that the reserved resources for the second service with low priority need to be allocated to the first service. In this way, unnecessary resource preemption can be avoided while ensuring the normal operation of both the first service and the second service, and service interruption of the second service with low priority is also prevented.

In the above scenario where the base station needs to switch the second service to the target resources since it allocates the reserved resources for the second service with low priority to the second service, the base station may first determine, based on a preset preemption parameter, whether it needs to switch the second service to the target resources. As illustrated in FIG. 4, in some embodiments, the above S202 includes S401 and S402.

At S401, it is determined, based on a preemption parameter, whether to switch the second service to the target resources, where the preemption parameter includes any one of a duration during which preemption of the reserved resources lasts, the number of times at which the reserved resources are preempted, and a service type of the second service.

Specifically, the preemption parameter includes any one of the duration during which preemption of the reserved resources last, the number of times at which the reserved resources are preempted, and the service type of the second service. The implementations of determining, based on the preemption parameter, whether to switch the second service to the target resources are described in detail below.

First, in a case where the preemption parameter is the duration during which preemption of the reserved resources for the second service lasts, if the preemption of the reserved resources for the second service would last for a short time period, the base station may determine not to switch the second service to the target resources; and if the preemption of the reserved resources for the second service would last for a long time period, the base station may determine to switch the second service to the target resources.

Second, in a case where the preemption parameter is the number of times at which the reserved resources are preempted, if the reserved resources for the second service are preempted at a low frequency, the base station may determine not to switch the second service to the target resources; and if the reserved resources for the second service are preempted at a high frequency, the base station may determine to switch the second service to the target resources.

Third, in a case where the preemption parameter is the service type of the second service, if the second service is not in an active/operating state or the second service operates a low rate, the base station may determine not to switch the second service to the target resources; and if the second service is in the active/operating state or the second service operates at a high rate, the base station may determine to switch the second service to the target resources.

At S402, in response to determining to switch the second service to the target resources, the second service is switched to the target resources.

In the embodiments, when the base station determines that the second service needs to be switched to the target resources, the base station may execute the above operations of switching the second service to the target resources. Specifically, the base station may switch the second service to the target resources different from the reserved resources through an RRC connection reconfiguration message or DCI.

In the embodiments, the process in which the base station determines, based on the preemption parameter, whether to switch the second service to the target resources is relatively simple, allowing the base station to quickly determine whether to switch the second service to the target resources. Therefore, when the base station determines that the second service needs to be switched to the target resources, the base station can quickly switch the second service to the target resources, ensuring the timeliness of switching the second service to the target resources and the service continuity of the second service, thereby avoiding service interruption of the second service.

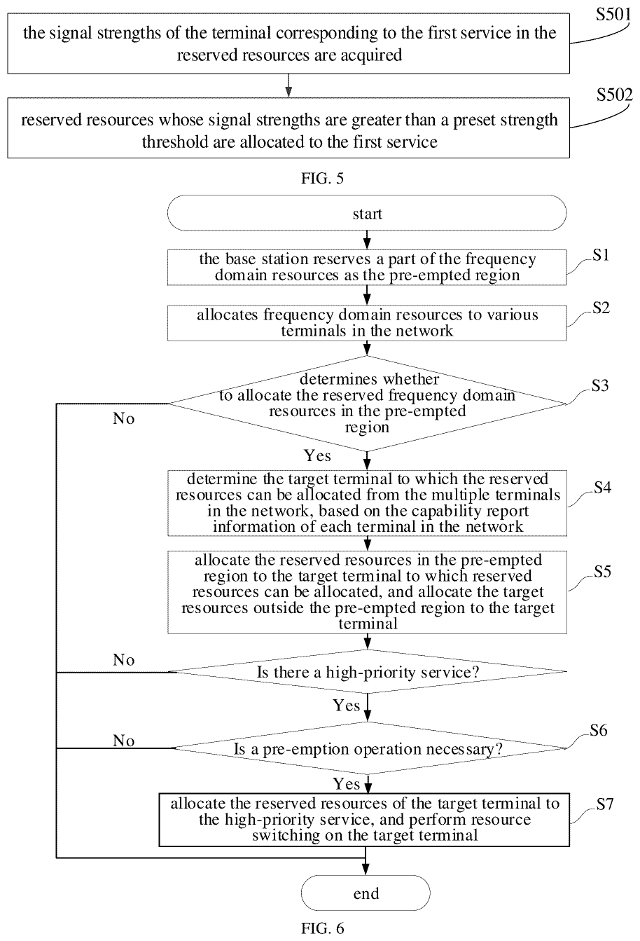

In the scenario where the base station allocates the reserved resources for the second service with low priority to the first service, the base station may allocate, to the first service, reserved resources each with relatively high signal strength among the reserved resources for the second service with low priority. As illustrated in FIG. 5, in some embodiments, the above S202 includes S501 and S502.

At S501, the signal strengths of the terminal corresponding to the first service in the reserved resources are acquired.

Generally, a terminal periodically reports a signal measurement report of a cell. Thus, based on the measurement report reported by the terminal, the base station may obtain the terminal's signal strengths in the cell's resources.

In the embodiments, as an alternative implementation, based on the signal measurement report about the reserved resources reported by the terminal corresponding to the first service, the base station may acquire the signal strengths of the terminal corresponding to the first service in the reserved resources. In some alternative implementations, the signal strengths of the terminal corresponding to the first service in the reserved resources acquired by the base station may be greater than a preset strength threshold, or may also be less than or equal to the preset strength threshold, which is not limited herein.

At S502, reserved resources whose signal strengths are greater than the preset strength threshold are allocated to the first service.

In the embodiments, the base station may compare the preset strength threshold with the acquired signal strengths of the terminal corresponding to the first service in the reserved resources, and allocate reserved resources whose signal strengths are greater than the preset strength threshold to the first service. That is, in the embodiments, the base station allocates reserved resources with relatively high signal strengths among the preempted reserved resources to the first service.

In the embodiments, the base station may acquire the signal strengths of the terminal corresponding to the first service in the reserved resources for the second service, determine reserved resources whose signal strengths exceed the preset strength threshold, and allocate the determined reserved resources to the first service. This ensures the normal operation of the first service, and improves the reliability of the operation of the first service.

For the convenience of those skilled in the art to understand, as illustrated in FIG. 6, the resource allocation method provided in the disclosure is described in detail below in combination with a complete example.

At S1, the base station reserves a part of the frequency domain resources as the preemption area.

At S2, the base station allocates frequency domain resources to various terminals in the network.

At S3, the base station determines, based on the number of terminals in the network or the range of the frequency domain resources of the network, whether it needs to allocate the reserved frequency domain resources in the preemption area.

At S4, when the base station determines that it needs to allocate the reserved frequency domain resources in the preemption area, the base station determines, from multiple terminals in the network, a target terminal whose reserved resources can be allocated, based on the capability report information of each of the multiple terminals in the network.

At S5, based on a preset allocation strategy, the base station allocates the reserved resources from the preemption area to the target terminal whose reserved resources can be allocated, and allocates the target resources outside the preemption area to the target terminal, where the preset allocation strategy includes that the frequency bands of the reserved resources do not overlap with the frequency bands of the target resources.

At S6, in response to a high-priority service appearing in the network, the base station determines whether a preemption operation is necessary.

At S7, in response to determining that the preemption operation is necessary, the base station allocates the reserved resources for the target terminal to the high-priority service, and performs resource switching for the target terminal, that is, switches the target terminal to the target resources different from the reserved resources.

It is notable that, for the description in the above S1-S7, reference may be made to the relevant description in the above embodiments, and the effects are similar, which will not be repeated here.

It can be understood that, although the operations are displayed sequentially according to the instructions of the arrows in the flowcharts involved in the embodiments as described above, these operations are not necessarily performed sequentially according to the sequence instructed by the arrows. Unless otherwise explicitly specified herein, execution of the operations is not strictly limited, and the operations may be performed in other sequences. Moreover, at least some of the operations in the flowcharts of the above embodiments may include multiple sub-operations or multiple stages, which are not necessarily executed at the same time but may be executed at different times, and the execution order of these sub-operations or stages is not necessarily sequential but may be executed alternately or interchangeably with other operations or at least some of the sub-operations or stages of other operations.

Based on the same inventive concept, some embodiments further provide a resource allocation apparatus for implementing the foregoing resource allocation method(s). Implementation solutions provided by the apparatus for solving problems are similar to the implementation solutions described in the foregoing methods. Therefore, for specific definitions in one or more resource allocation apparatus embodiments provided below, reference may be made to the definitions of the resource allocation methods in the foregoing descriptions.

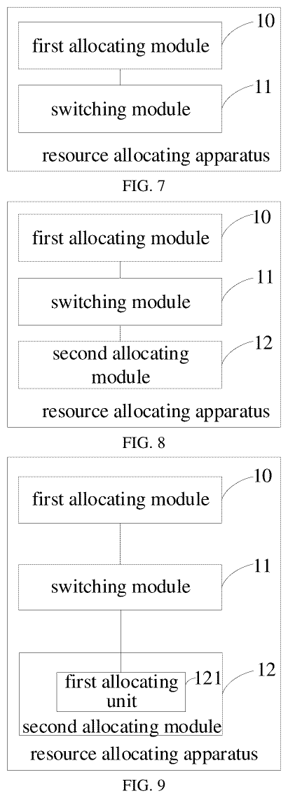

In some embodiment, as illustrated in FIG. 7, a resource allocation apparatus is provided. The resource allocation apparatus includes a first allocating module 10 and a switching module 11.

The first allocating module 10 is configured to, in a case where a first service needs to preempt resources of a second service, allocate reserved resources for the second service to the first service, where a priority of the first service is higher than a priority of the second service.

The switching module 11 is configured to switch the second service to target resources, wherein the target resources are resources different from the reserved resources.

The resource allocation apparatus provided in the embodiments can execute the above method embodiments, and the implementation principle and technical effects of the apparatus and the method are similar, which will not be repeated here.

Based on the above embodiments, as illustrated in FIG. 8, in some alternative implementations, the above apparatus further includes a second allocating module 12.

The second allocating module 12 is configured to allocate the reserved resources from a preemption area to a target terminal corresponding to the second service, and allocate the target resources outside the preemption area to the target terminal, where the preemption area comprises reserved frequency domain resources.

The resource allocation apparatus provided in the embodiments can execute the above method embodiments, and the implementation principle and technical effect of the apparatus and the method are similar, which will not be repeated here.

Based on the above embodiments, as illustrated in FIG. 9, in some alternative implementations, the second allocating module 12 includes a first allocating unit 121.

The first allocating unit 121 is configured to allocate the reserved resources from the preemption area to the target terminal, and allocate the target resources outside the preemption area to the target terminal, based on a preset allocation strategy including that frequency bands of the reserved resources does not overlap with frequency bands of the target resources.

The resource allocation apparatus provided in the embodiments can execute the above method embodiments, and the implementation principle and technical effect of the apparatus and the method are similar, which will not be repeated here.

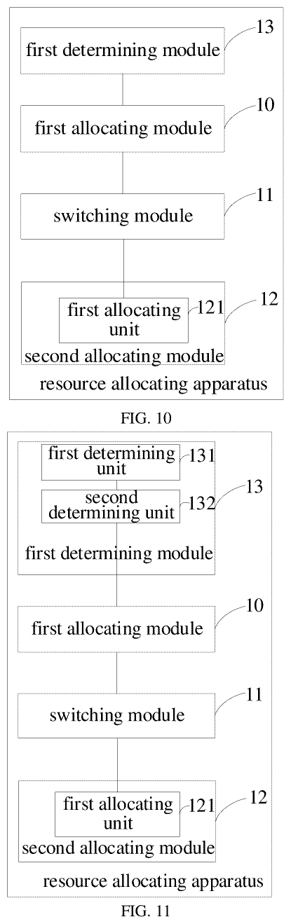

Based on the above embodiments, as illustrated in FIG. 10, in some alternative implementations, the above apparatus further includes a first determining module 13.

The first determining module 13 is configured to determine, based on capability report information of each terminal in a network, the target terminal from the multiple terminals.

The resource allocation apparatus provided in the embodiments can execute the above method embodiments, and the implementation principle and technical effect of the apparatus and the method are similar, which will not be repeated here.

Based on the above embodiments, as illustrated in FIG. 11, in some alternative implementations, the first determining module 13 includes a first determining unit 131 and a second determining unit 132.

The first determining unit 131 is configured to determine, based on a quantity of the plurality of terminals in the network or a range of frequency domain resources of the network, whether the frequency domain resources in the preemption area need be to allocated.

The second determining unit 132 is configured to in response to determining that the frequency domain resources in the preemption area need to be allocated, determine, based on the capability report information of each of the plurality of terminals, the target terminal from the plurality of terminals.

The resource allocation apparatus provided in the embodiments can execute the above method embodiments, and the implementation principle and technical effect of the apparatus and the method are similar, which will not be repeated here.

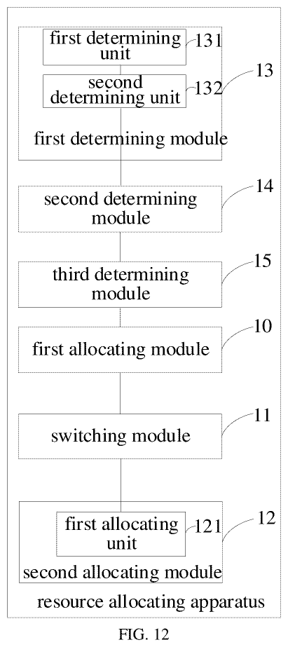

Based on the above embodiments, as illustrated in FIG. 12, in some alternative implementations, the above apparatus further includes a second determining module 14 and a third determining module 15.

The second determining module 14 is configured to determine whether there are available frequency domain resources in the preemption area.

The third determining module 15 is configured to in response to determining that there are no available frequency domain resources in the preemption area, determine that the reserved resources for the second service need to be allocated to the first service.

The resource allocation apparatus provided in the embodiments can execute the above method embodiments, and the implementation principle and technical effect of the apparatus and the method are similar, which will not be repeated here.

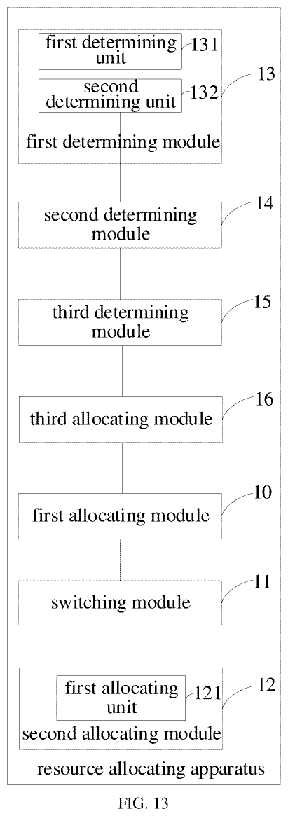

Based on the above embodiments, as illustrated in FIG. 13, in some alternative implementations, the above apparatus further includes a third allocating module 16.

The third allocating module 16 is configured to in response to determining that there are available frequency domain resources in the preemption area, allocate the available frequency domain resources to the first service.

The resource allocation apparatus provided in the embodiments can execute the above method embodiments, and the implementation principle and technical effect of the apparatus and the method are similar, which will not be repeated here.

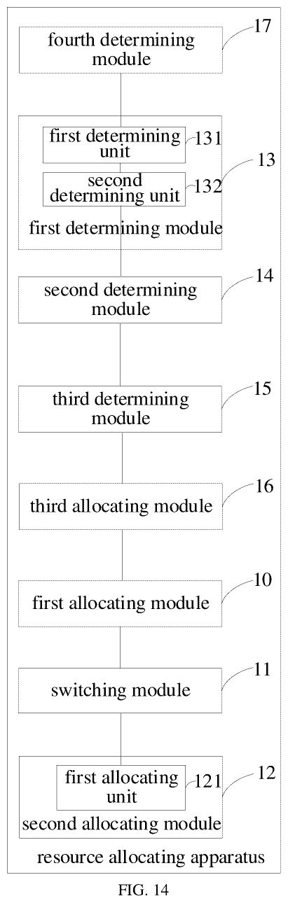

Based on the above embodiments, as illustrated in FIG. 14, in some alternative implementations, the above apparatus further includes a fourth determining module 17.

The fourth determining module 17 is configured to determine the preemption area based on total frequency domain resources of a network and a preset preemption resource proportion.

The resource allocation apparatus provided in the embodiments can execute the above method embodiments, and the implementation principle and technical effect of the apparatus and the method are similar, which will not be repeated here.

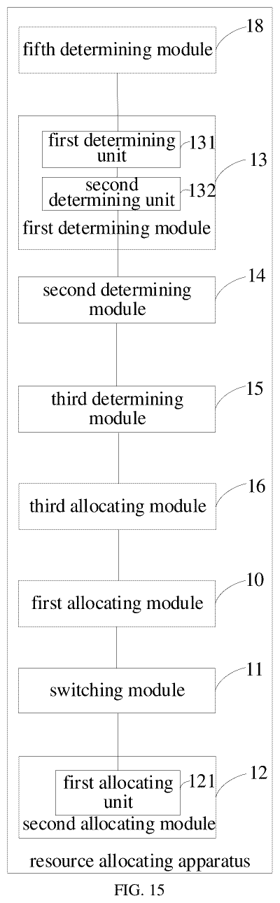

Based on the above embodiments, as illustrated in FIG. 15, in some alternative implementations, the above apparatus further includes a fifth determining module 18.

The fifth determining module 18 is configured to determine, based on a quantity of resources of the first service during a historical time period, the preemption area from total frequency domain resources of a network.

It is notable that FIG. 14 and FIG. 15 are two parallel embodiments, and there is no inclusion relationship between FIG. 14 and FIG. 15.

The resource allocation apparatus provided in the embodiments can execute the above method embodiments, and the implementation principle and technical effect of the apparatus and the method are similar, which will not be repeated here.

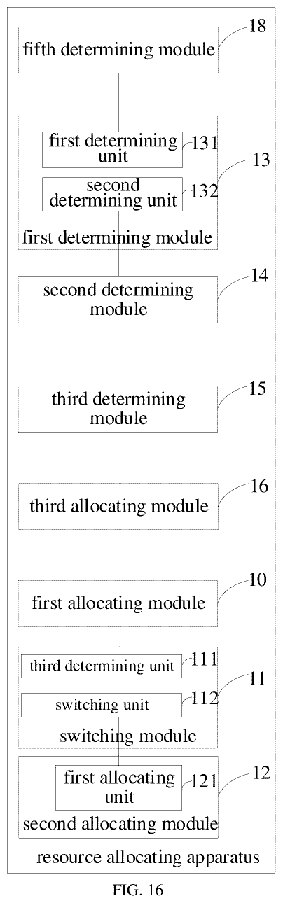

Based on the above embodiments, as illustrated in FIG. 16, in some alternative implementations, the switching module 11 includes a third determining unit 111 and a switching unit 112.

The third determining unit 111 is configured to determine, based on a preemption parameter, whether to switch the second service to the target resources, where the preemption parameter includes any one of a duration during which preemption of the reserved resources lasts, the number of times at which the reserved resources are preempted, and a service type of the second service.

The switching unit 112 is configured to in response to determining to switch the second service to the target resources, switch the second service to the target resources.

The resource allocation apparatus provided in the embodiments can execute the above method embodiments, and the implementation principle and technical effect of the apparatus and the method are similar, which will not be repeated here.

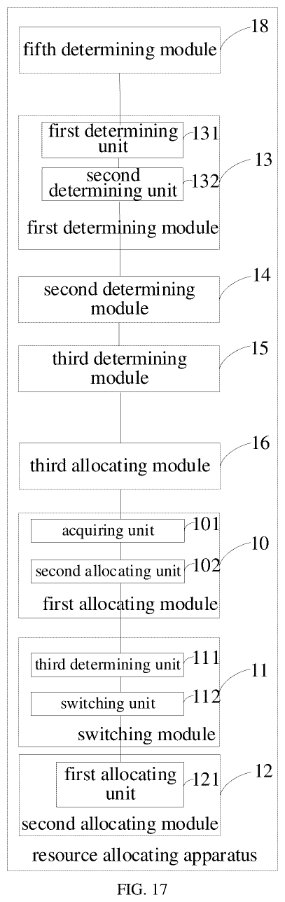

Based on the above embodiments, as illustrated in FIG. 17, in some alternative implementations, the first allocating module 10 includes an acquiring unit 101 and a second allocating unit 102.

The acquiring unit 101 is configured to acquire signal strengths of a terminal corresponding to the first service in the reserved resources.

The second allocating unit 102 is configured to allocate, to the first service, a part of the reserved resources whose signal strength are greater than a preset strength threshold.

The resource allocation apparatus provided in the embodiments can execute the above method embodiments, and the implementation principle and technical effect of the apparatus and the method are similar, which will not be repeated here.

The various modules in the resource allocation apparatus may be implemented in whole or in part by software, hardware, and a combination thereof. The foregoing modules may be built in or independent of a processor of a computer device in a form of hardware, or may be stored in a memory of the computer device in a form of software, for the processor to invoke the software to execute operations corresponding to the foregoing modules.

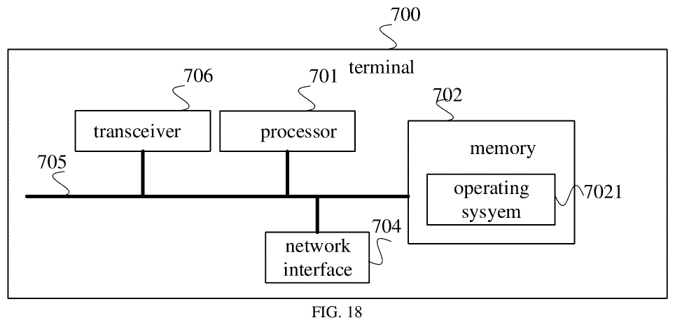

A base station is provided in some embodiments, and FIG. 18 illustrates the internal structural diagram of the base station. The base station includes at least one processor 701, a memory 702, and at least one network interface 704. The various components in the base station are coupled together through a bus system 705. It can be understood that the bus system 705 is used to realize the connection and communication between these components. In addition to a data bus, the bus system 705 further includes a power bus, a control bus, and a status signal bus. However, for clarity, the various buses are labeled as bus systems 705 in FIG. 18. In addition, in the embodiments of the disclosure, the base station further includes a transceiver 706. The transceiver may be multiple components, namely, a transmitter and a receiver, providing a unit for communicating with various other devices on a transmission medium.

It can be understood that the memory 702 in the embodiments of the disclosure may be a volatile memory or a non-volatile memory, or may include both volatile and non-volatile memories. Specifically, the non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM), which is used as an external cache. By way of example but not limitation, many forms of RAM are available, such as static random-access memory (SRAM), dynamic random-access memory (DRAM), synchronous dynamic random-access memory (SDRAM), double data rate synchronous dynamic random-access memory (DDRSDRAM), enhanced synchronous dynamic random-access memory (ESDRAM), synchronous link dynamic random-access memory (SLDRAM) and direct RAM bus random access memory (DRRAM). The memory 702 of the system and method described in the embodiments of the disclosure is intended to include, but is not limited to, these memories and any other suitable types of memories.

In some implementations, the memory 702 stores the following elements: executable modules or data structures, or subsets thereof, or expansion sets thereof: an operating system 7021. The operating system 7021 includes various system programs, such as a framework layer, a core library layer, a driver layer, etc., which are used to implement various basic services and process hardware-based tasks.

In the embodiments of the disclosure, by calling the program or instructions stored in the memory 702, the processor is configured to, in a case where a first service needs to preempt resources of a second service, allocate reserved resources for the second service to the first service, where a priority of the first service is higher than a priority of the second service; and switch the second service to target resources, where the target resources are resources different from the reserved resources.

A part or all of the methods disclosed in the above embodiments of the disclosure may be applied to the processor 701, or implemented by the processor 701, or implemented by the processor 701 in cooperation with other components (such as a transceiver). The processor 701 may be an integrated circuit chip with signal processing capabilities. In the implementation process, each operation of the above method may be implemented by an integrated logic circuit of hardware in the processor 701 or by instructions in the form of software. The above processor 701 may be a general-purpose processor, a digital signal processor (DSP), an application specific integrated circuit (ASIC), a field programmable gate array (FPGA) or other programmable logic devices, discrete gates or transistor logic devices, discrete hardware components. The processor may be configured to implement or execute the methods, operations and logic block diagrams disclosed in the embodiments of the disclosure. The general-purpose processor may be a microprocessor or any regular processor. The operations of the methods disclosed in the embodiments of the disclosure may be directly embodied as being performed by a hardware decoding processor, or being performed by a combination of hardware and software modules in the decoding processor. The software module may be arranged in a random memory, a flash memory, a read-only memory, a programmable read-only memory, an electrically erasable programmable memory, a register, or a storage medium which is mature in this field. The storage medium is arranged in the memory 702, and the processor 701 reads information in the memory 702, and fulfills the operations of the above methods by combining with the hardware thereof.

It should be appreciated that, the embodiments of the disclosure may be implemented by hardware, software, firmware, middleware, microcode or a combination thereof. For the hardware implementation, the processor may include one or more of an application specific integrated circuit (ASIC), a digital signal processor (DSP), a digital signal processing device (DSPD), a programmable logic (PLD), a field programmable gate array (FPGA), a general-purpose processor, a controller, a microcontroller, a microprocessor, other electronic units capable of achieving the functions of the disclosure or a combination thereof.

For the software implementation, the scheme in the embodiments of the disclosure may be implemented through modules capable of achieving the functions (e.g., processes or functions) in the disclosure. Software codes may be stored in the memory and executed by the processor 701. The memory may be implemented inside or outside the processor 701.

In some embodiments, the processor is further configured to allocate the reserved resources from a preemption area to a target terminal corresponding to the second service, and allocate the target resources outside the preemption area to the target terminal, where the preemption area includes reserved frequency domain resources.

In some embodiments, the processor is specifically configured to allocate the reserved resources from the preemption area to the target terminal, and allocate the target resources outside the preemption area to the target terminal, based on a preset allocation strategy including that frequency bands of the reserved resources do not overlap with frequency bands of the target resources.

In some embodiments, the processor is configured to determine, based on capability report information of each terminal in a network, the target terminal from the multiple terminals.

In some embodiments, the processor is specifically configured to determine, based on a quantity of the plurality of terminals in the network or a range of frequency domain resources of the network, whether the frequency domain resources in the preemption area need be to allocated; and in response to determining that the frequency domain resources in the preemption area need to be allocated, determine, based on the capability report information of each of the multiple terminals, the target terminal from the multiple terminals.

In some embodiments, the processor is configured to determine whether there are available frequency domain resources in the preemption area; and in response to determining that there are no available frequency domain resources in the preemption area, determine that the reserved resources for the second service need to be allocated to the first service.

In some embodiments, the processor is configured to in response to determining that there are available frequency domain resources in the preemption area, allocate the available frequency domain resources to the first service.

In some embodiments, the processor is configured to determine the preemption area based on total frequency domain resources of a network and a preset preemption resource proportion.

In some embodiments, the processor is configured to determine, based on a quantity of resources of the first service during a historical time period, the preemption area from total frequency domain resources of a network.

In some embodiments, the processor is configured to determine, based on a preemption parameter, whether to switch the second service to the target resources, wherein the preemption parameter includes any one of a duration during which preemption of the reserved resources lasts, the number of times at which the reserved resources are preempted, and a service type of the second service; and in response to determining to switch the second service to the target resources, switch the second service to the target resources.

In the embodiments, the processor is configured to acquire signal strengths of a terminal corresponding to the first service in the reserved resources; and allocate, to the first service, a part of the reserved resources whose signal strengths are greater than a preset strength threshold.

Those skilled in the art can appreciate that the structure illustrated in FIG. 18 is merely a block diagram of a partial structure related to the scheme of the disclosure, and does not constitute a limitation on the computer device to which the scheme of the disclosure is applied. The specific computer device may include more or fewer components than the components illustrated in the drawings, or combine certain components, or have a different arrangement of components.

The embodiments of the disclosure further provide a computer-readable storage medium. One or more non-volatile computer-readable storage media containing computer-executable instructions, when the computer-executable instructions are executed by one or more processors, the one or more processors are caused to execute the operations of the resource allocation method.

A computer-readable storage medium storing a computer program thereon is provided in some embodiments. The computer program, when being executed by a processor, implements following operations:
in a case where a first service needs to preempt resources of a second service, allocating reserved resources for the second service to the first service, where a priority of the first service is higher than a priority of the second service; and
switching the second service to target resources, where the target resources are resources different from the reserved resources.

In some embodiment, the computer program, when executed by the processor, further implements the following operations:
allocating the reserved resources from a preemption area to a target terminal corresponding to the second service, and allocating the target resources outside the preemption area to the target terminal, where the preemption area includes reserved frequency domain resources.

In some embodiment, the computer program, when executed by the processor, further implements the following operations:
allocating the reserved resources from the preemption area to the target terminal and allocating the target resources outside the preemption area to the target terminal, based on a preset allocation strategy including that frequency bands of the reserved resources do not overlap with frequency bands of the target resources.

In some embodiment, the computer program, when executed by the processor, further implements the following operations:
determining, based on capability report information of each of multiple terminals in a network, the target terminal from the multiple terminals.

In some embodiment, the computer program, when executed by the processor, further implements the following operations:
determining, based on a quantity of the multiple terminals in the network or a range of frequency domain resources of the network, whether the frequency domain resources in the preemption area need be to allocated; and
in response to determining that the frequency domain resources in the preemption area need to be allocated, determining, based on the capability report information of each of the multiple terminals, the target terminal from the multiple terminals.

In some embodiment, the computer program, when executed by the processor, further implements the following operations:
determining whether there are available frequency domain resources in the preemption area; and
in response to determining that there are no available frequency domain resources in the preemption area, determining that the reserved resources of the second service need to be allocated to the first service.

In some embodiment, the computer program, when executed by the processor, further implements the following operations:
in response to determining that there are available frequency domain resources in the preemption area, allocating the available frequency domain resources to the first service.

In some embodiment, the computer program, when executed by the processor, further implements the following operations:
determining the preemption area based on total frequency domain resources of a network and a preset preemption resource proportion.

In some embodiment, the computer program, when executed by the processor, further implements the following operations:
determining, based on a quantity of resources of the first service during a historical time period, the preemption area from total frequency domain resources of a network.

In some embodiment, the computer program, when executed by the processor, further implements the following operations:
determining, based on a preemption parameter, whether to switch the second service to the target resources, where the preemption parameter comprises any one of a duration during which preemption of the reserved resources lasts, the number of times at which the reserved resources are preempted, and a service type of the second service; and
in response to determining to switch the second service to the target resources, switching the second service to the target resources.

In some embodiment, the computer program, when executed by the processor, further implements the following operations:
acquiring signal strengths of a terminal corresponding to the first service in the reserved resources; and
allocating, to the first service, a part of the reserved resources whose signal strengths are greater than a preset strength threshold.

The embodiments of the disclosure further provide a computer program product including instructions which, when being executed on a computer, enables the computer to execute the resource allocation method.

The computer program product is provided in some embodiments. The computer program product comprises a computer program which, when being executed by a processor, implements the following operations:

in a case where a first service needs to preempt resources of a second service, allocating reserved resources for the second service to the first service, where a priority of the first service is higher than a priority of the second service; and switching the second service to target resources, wherein the target resources are resources different from the reserved resources.

In some embodiment, the computer program, when executed by the processor, further implements the following operations:
allocating the reserved resources in from preemption area to a target terminal corresponding to the second service, and allocating the target resources outside the preemption area to the target terminal, where the preemption area includes reserved frequency domain resources.

In some embodiment, the computer program, when executed by the processor, further implements the following operations:
allocating the reserved resources from the preemption area to the target terminal and allocating the target resources outside the preemption area to the target terminal, based on a preset allocation strategy including that frequency bands of the reserved resources do not overlap with frequency bands of the target resources.

In some embodiment, the computer program, when executed by the processor, further implements the following operations:
determining, based on capability report information of each of multiple terminals in a network, the target terminal from the multiple terminals.

In some embodiment, the computer program, when executed by the processor, further implements the following operations:
determining, based on a quantity of the multiple terminals in the network or a range of frequency domain resources of the network, whether the frequency domain resources in the preemption area need be to allocated; and
in response to determining that the frequency domain resources in the preemption area need to be allocated, determining, based on the capability report information of each of the multiple terminals, the target terminal from the multiple terminals.

In some embodiment, the computer program, when executed by the processor, further implements the following operations:
determining whether there are available frequency domain resources in the preemption area; and
in response to determining that there are no available frequency domain resources in the preemption area, determining that the reserved resources of the second service need to be allocated to the first service.

In some embodiment, the computer program, when executed by the processor, further implements the following operations:

in response to determining that there are available frequency domain resources in the preemption area, allocating the available frequency domain resources to the first service.

In some embodiment, the computer program, when executed by the processor, further implements the following operations:
determining the preemption area based on total frequency domain resources of a network and a preset preemption resource proportion.

In some embodiment, the computer program, when executed by the processor, further implements the following operations:
determining, based on a quantity of resources of the first service during a historical time period, the preemption area from total frequency domain resources of a network.

In some embodiment, the computer program, when executed by the processor, further implements the following operations:
determining, based on a preemption parameter, whether to switch the second service to the target resources, where the preemption parameter comprises any one of a duration during which preemption of the reserved resources lasts, the number of times at which the reserved resources are preempted, and a service type of the second service; and
in response to determining to switch the second service to the target resources, switching the second service to the target resources.

In some embodiment, the computer program, when executed by the processor, further implements the following operations:
acquiring signal strengths of a terminal corresponding to the first service in the reserved resources; and
allocating, to the first service, a part of the reserved resources whose signal strengths are greater than a preset strength threshold.

Those skilled in the art can understand that all or part of the processes in the methods of the above embodiments can be implemented by instructing relevant hardware through a computer program. The computer program may be stored in a non-transitory computer-readable storage medium. When the computer program is executed, the process of any of the above embodiments can be realized. Specifically, any reference to the memory, database or other medium used in the embodiments provided in the disclosure may include at least one of non-volatile and volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random-access memory (FRAM), a phase change memory (PCM), a graphene memory, etc. The volatile memory may include random access memory (RAM) or external cache memory, etc. As an illustration and not limitation, RAM may be implemented in various forms, such as static random-access memory (SRAM) or dynamic random-access memory (DRAM). The database involved in the various embodiment provided in the disclosure may include at least one of a relational database and a non-relational database. The non-relational databases may include distributed databases based on blockchains, etc., but are not limited thereto. The processor involved in the various embodiments provided in the disclosure may be a general-purpose processor, a central processing unit, a graphics processor, a digital signal processor, a programmable logic device, a data processing logic device based on quantum computing, etc., but are not limited thereto.

The various technical features of the above-described embodiments may be combined arbitrarily. To make the description concise, not all possible combinations of the technical features in the embodiments are described. However, as long as there is no contradiction in the combination of these technical features, all combinations of these technical features should be considered to be within the scope of the specification.

The foregoing embodiments illustrate only several implementations of this disclosure and are described in detail, which however are not to be construed as limiting the scope of this disclosure. It is notable that, for those skilled in the art, several modifications and improvements can be made without departing from the idea of this disclosure, but all of them should fall within the protection scope of this disclosure. Therefore, the protection scope of the disclosure should be subject to the appended claims.

What is claimed is:

1. A resource allocation method, for a base station, the method comprising:
in response to a first service preempting resources of a second service, allocating reserved resources for the second service to the first service, wherein a priority of the first service is higher than a priority of the second service; and
switching the second service to target resources, wherein the target resources are resources different from the reserved resources.

2. The resource allocation method as claimed in claim 1, further comprising:
allocating the reserved resources from a preemption area to a target terminal corresponding to the second service, and allocating the target resources outside the preemption area to the target terminal, wherein the preemption area comprises reserved frequency domain resources.

3. The resource allocation method as claimed in claim 2, wherein allocating the reserved resources from the preemption area to the target terminal corresponding to the second service and allocating the target resources outside the preemption area to the target terminal, comprises:
allocating the reserved resources from the preemption area to the target terminal and allocating the target resources outside the preemption area to the target terminal, based on a preset allocation strategy comprising that frequency bands of the reserved resources do not overlap with frequency bands of the target resources.

4. The resource allocation method as claimed in claim 3, further comprising:
determining, based on capability report information of each of a plurality of terminals in a network, the target terminal from the plurality of terminals.

5. The resource allocation method as claimed in claim 4, wherein determining, based on the capability report information of each of the plurality of terminals in the network, the target terminal from the plurality of terminals, comprises:
determining, based on a quantity of the plurality of terminals in the network or a range of frequency domain resources of the network, whether the frequency domain resources in the preemption area need be to allocated; and
in response to determining that the frequency domain resources in the preemption area need to be allocated, determining, based on the capability report information of each of the plurality of terminals, the target terminal from the plurality of terminals.

6. The resource allocation method as claimed in claim 2, further comprising:
determining whether there are available frequency domain resources in the preemption area; and
in response to determining that there are no available frequency domain resources in the preemption area, determining that the reserved resources for the second service need to be allocated to the first service.

7. The resource allocation method as claimed in claim 6, further comprising:
in response to determining that there are available frequency domain resources in the preemption area, allocating the available frequency domain resources to the first service.

8. The resource allocation method as claimed in claim 2, further comprising:
determining the preemption area, based on total frequency domain resources of a network and a preset preemption resource proportion.

9. The resource allocation method as claimed in claim 2, further comprising:
determining, based on a quantity of resources of the first service during a historical time period, the preemption area from total frequency domain resources of a network.

10. The resource allocation method as claimed in claim 1, wherein switching the second service to the target resources, comprises:
determining, based on a preemption parameter, whether to switch the second service to the target resources, wherein the preemption parameter comprises any one of a duration during which preemption of the reserved resources lasts, the number of times at which the reserved resources are preempted, and a service type of the second service; and
in response to determining to switch the second service to the target resources, switching the second service to the target resources.

11. The resource allocation method as claimed in claim 1, wherein allocating the reserved resources for the second service to the first service, comprises:
acquiring signal strengths of a terminal corresponding to the first service in the reserved resources; and
allocating, to the first service, a part of the reserved resources whose signal strengths are greater than a preset strength threshold.

12. The resource allocation method as claimed in claim 1, wherein the method further comprises:
obtaining a quality of service parameter of each of the first service and the second service; and
determining the priority of the first service based on the quality of service parameter of the first service, and determining the priority of the second service based on the quality of service parameter of the second service.

13. The resource allocation method as claimed in claim 12, wherein determining the priority of the first service based on the quality of service parameter of the first service, and determining the priority of the second service based on the quality of service parameter of the second service, comprises:
determining the first service as a high-priority service, in response to determining, based on the quality of service parameter of the first service, that the first service is an ultra-reliable and low latency communications service or an automatic driving vehicle-to-everything service; and
determining the second service as a low-priority service, in response to determining, based on the quality of service parameter of the second service, that the second service is an enhanced mobile broadband service.

14. The resource allocation method as claimed in claim 1, wherein the method further comprises:
determining that the priority of the first service is higher than the priority of the second service, in response to the first service having more strict latency requirements than the second service.

15. The resource allocation method as claimed in claim 1, wherein switching the second service to the target resources, comprises:
switching the second service to the target resources through a radio resource control connection reconfiguration message or downlink control information.

16. A base station, comprising a transceiver, a memory and a processor, wherein the memory stores a computer program which, when being executed by the processor, causes the processor to:
allocate, in response to a first service preempting resources of a second service, reserved resources for the second service to the first service, wherein a priority of the first service is higher than a priority of the second service; and
switch the second service to target resources, wherein the target resources are different from the reserved resources.

17. The base station as claimed in claim 16, wherein the computer program, when being executed by the processor, further causes the processor to:
allocate the reserved resources from a preemption area to a target terminal corresponding to the second service and allocate target resources outside the preemption area to the target terminal, based on a preset allocation strategy comprising that frequency bands of the reserved resources do not overlap with frequency bands of the target resources.

18. The base station as claimed in claim 17, wherein the computer program, when being executed by the processor, further causes the processor to:
in response to determining, based on a quantity of a plurality of terminals in a network or a range of frequency domain resources of the network, that frequency domain resources in the preemption area need to be allocated, determine, based on a capability report information of each of the plurality of terminals, the target terminal from the plurality of terminals.

19. The base station as claimed in claim 16, wherein the computer program, when being executed by the processor, further causes the processor to:
in response to determining that there are no available frequency domain resources in the preemption area, determine that the reserved resources for the second service need to be allocated to the first service;
in response to determining that there are available frequency domain resources in the preemption area, allocate the available frequency domain resources to the first service.

20. A non-transitory computer-readable storage medium storing a computer program thereon, wherein the computer program, when being executed by a processor, causes the processor to execute a resource allocation method comprising:
in response to a first service preempting resources of a second service, allocating reserved resources for the second service to the first service, wherein a priority of the first service is higher than a priority of the second service; and
switching the second service to target resources, wherein the target resources are different from the reserved resources.
